(19) United States
(12) Patent Application Publication
(10) Pub. No.: US 2015/0217872 A1
(43) Pub. Date: Aug. 6, 2015

(54) METHOD FOR SLOT CREATION AT AN AIRPORT

(71) Applicants: Isaiah W. Cox, London (GB); Joseph J. Cox, Portland, OR (US)

(72) Inventors: Isaiah W. Cox, London (GB); Joseph J. Cox, Portland, OR (US)

(21) Appl. No.: 14/341,750

(22) Filed: Jul. 25, 2014

(30) Foreign Application Priority Data
Jan. 31, 2014 (US) PCT/US14/14210

(51) Int. Cl. B64F 1/22; B64C 25/40; B64F 1/00

(52) U.S. Cl. CPC B64F 1/225; B64F 1/002; B64C 25/405

(57) ABSTRACT

A method is provided for creating additional takeoff and landing slots at airports that are constrained from operation by curfews that limit the hours when aircraft can operate. Aircraft may be moved on the ground to and from takeoff and landing runways without operation of the aircraft's engines entirely by tow vehicles, aircraft transfer apparatus, or non-engine drive means so that aircraft are ready to take off at the expiration of an airport's morning curfew. Aircraft may also land just prior to start of an airport's evening curfew and be moved to parking destinations entirely by tow vehicles, aircraft transfer apparatus, or non-engine drive means without operating engines. Airport capacity may be increased without requiring infrastructure expansion.

### PRIORITY CLAIM

This application claims priority from International Patent Application No. PCT/US2014/014210, filed 31 Jan. 2014, now withdrawn, the disclosure of which is fully incorporated herein by reference.

### TECHNICAL FIELD

The present invention relates generally to creating slots at an airport and, specifically, to a method for increasing airline slots at an airport with slot and/or curfew controls.

### BACKGROUND OF THE INVENTION

In this era of increased air travel, many airports have reached their capacity to accommodate the numbers of aircraft seeking to use them. Delays in taking off and landing have increased as air traffic has increased to meet the demand for air travel. At some airports, the demand for runway and gate access exceeds the supply, which has resulted in the allocation of both takeoff and landing slots and gates. The number of flights an airport can handle in a given time period is fixed, and these resources are allocated to airlines to ensure that runway and gate access is maximized and delays are minimized. The allocation of takeoff and landing slots and gate access to airlines was instituted to control air traffic into and out of busy airports, in an effort to eliminate or at least control and reduce excessive and costly time delays, as well as to expand an airport's limited capacity. Some less busy airports have instituted controls for takeoff slots and landing slots only during peak usage times.

There are currently over 150 airports around the world, almost 100 in Europe alone, where demand exceeds airport capacity, and, as a result, takeoff slots and landing slots are allocated to the airlines that routinely take off and land at these airports. In many of these airports, gates at terminals, which are generally rented from airport owners under long term leases, are also at a premium, and the leases are bought and sold among airlines. The United States currently has only three takeoff and landing slot-controlled airports and four others where takeoff slots are allocated during peak hours. Terminal gates are also at a premium at these airports. The numbers of available takeoff slots, landing slots, and gates are generally limited, and some airlines have takeoff slots, landing slots, and terminal gate rights that have been “grandfathered” for historical reasons. To schedule departures and/or arrivals at takeoff or landing slot-controlled airports, airlines must acquire the necessary gates and takeoff and landing slots before they can use these airports. If the airport is one that does not have a shortage of gates or takeoff and landing slots, an airline can acquire the necessary slots fairly easily. If, however, the airport has no gates or takeoff or landing slots available, obtaining these required resources presents challenges for an airline.

Slot management systems have been proposed, as have methods and systems for allocating airport slots. U.S. Pat. No. 6,789,011 to Baiada et al and U.S. Patent Application Publication No. US2009/0089789 to Faltings et al, for example, describe such systems. Airlines are generally not in favor of such systems, and a need for a slot management system has been referred to as indicative of a failure to take the steps needed to keep up with air travel demand. Airlines have invested billions of dollars in aircraft and must have the degree of certainty provided by available takeoff and landing slots and airport terminal gates to operate profitably and to ensure the airlines' access to airports in the future.

Airlines presently consider their gates and takeoff and landing slots to be airline property and would like to be free to use these slots as they desire. Such gates and takeoff and landing slots generally have a monetary value, and airlines sell and lease them as they would any other asset. Some economists and others view the current system as anti-competitive and urge that airlines with grandfathered gates and congested peak time takeoff and landing slots may have an unfair advantage, especially when airlines operate flights primarily to guard their slots and keep out competitors. This view has apparently not affected the market for slots, however. At some airports, London Heathrow, for example, gates and takeoff slots are in great demand and generally sell for at least £2 million to £3 million each. Very desirable gates and takeoff slots may command even higher prices. Gates and takeoff or landing slots tend to be transferred on a yearly basis, with the original putative owner retaining underlying ownership and the ability to resell these same gates and takeoff or landing slots.

New takeoff and landing slots, especially at busy airports, seldom become available, and both new airlines and established airlines that want to expand may have limited or no access to slots. Under some arrangements, if an airline does not use an allocated gate or a takeoff or landing slot 80% of the time, the airline risks losing these assets, and another airline could acquire the gate or the takeoff or landing slot, but this is not a reliable way for an airline to obtain a gate or a takeoff or landing slot. Since airlines may swap and exchange gates and takeoff and landing slots among themselves, a gate or a takeoff or landing slot might be acquired in this manner. Takeoff and landing slots may also be acquired at auction. The International Air Transport Association (IATA) has suggested that when new takeoff and landing slots become available, they could be put into a slot pool, with a portion of the slots required to be made available to new entrant carriers that are currently operating with a small number of slots, for example, on the order of less than two pairs of slots per day. A single gate may be used in connection with many takeoff slots and/or landing slots, and an airline's acquisition of gates is not necessarily tied to the airline's acquisition of takeoff or landing slots. Takeoff and landing slots may be limited to the number of runways at an airport and distances allowed between aircraft.

All of the foregoing suggestions, however, are based on an airline increasing its takeoff and landing slots or gates by the re-allocation of existing resources. The addition of new takeoff slots and landing slots and the more intensive use of gates present other challenges. While these new takeoff and landing slots and increased gate use could be achieved by expanding airport capacity, few airports have that capability. Even when expansion is possible, it could be decades before the regulatory approvals are obtained and the construction required for the infrastructure expansion needed to increase takeoff and landing slots and add gates is completed. Even if the necessary regulatory approvals could be obtained easily and quickly, which is rarely the case, the addition of new runways, new taxiways, and new terminal gates to an airport is very expensive.

Expanding the airport operating time could produce new takeoff and landing slots. Many of the world's major airports have curfews or use restrictions, however, which can drastically reduce airport capacity. Limitations and restrictions on airport operation can also reduce the value of building additional airport infrastructure. Most airports currently do not operate at night or during other selected hours because of curfews. A curfew demands that all takeoffs and landings occur only within a specific time period and prohibits all takeoffs and landings outside this time period. The majority of airports in Europe, for example, are curfew-controlled, and this is not likely to change. The basis for most curfews is the noise produced by incoming and outgoing aircraft. The reduction of engine emissions is an additional reason for limiting airport operating hours. Aircraft noise becomes an issue when aircraft are required to use engine thrust for ground travel prior to take off and after landing. Even when a tug or tow vehicle is used to push the aircraft back from a gate, the aircraft's engines are still presently required for aircraft ground movement between pushback and takeoff, and this generates significant noise and other pollution.

Moving an aircraft autonomously on the ground without the use of a tug or tow vehicle or relying on thrust from the aircraft's engines has been proposed. For example, U.S. Pat. No. 7,891,609 to Cox et al, owned in common with the present application, describes moving an aircraft along taxiways using at least one self propelled undercarriage wheel to improve turnaround time. Moving an aircraft to a takeoff runway with an automated tug without the use of aircraft engines has also been proposed by Leblanc in U.S. Pat. No. 6,305,484. Neither of these patents, however, suggests a method for actually creating or increasing the number of takeoff and landing slots available at a curfew-controlled or any other airport.

Neither these patents nor the other art of which Applicant is aware suggests a method for creating or increasing slots at a curfew-controlled airport that includes moving an aircraft on the ground without operation of the aircraft's engines so that the aircraft can be on the runway ready for takeoff when an airport's curfew restrictions are lifted. The prior art, moreover, does not suggest a method for creating slots at a curfew-controlled or other airport that includes moving an aircraft that has landed immediately at curfew expiration without operation of the aircraft's engines from a touch down location to a parking location or moving an aircraft from a gate to a takeoff location without operation of aircraft engines to be ready to takeoff at the expiration of curfew.

The prior art, therefore, fails to suggest a method for creating and/or increasing the number of takeoff and landing slots available at an airport that does not rely on extending the airport hours of operation, reducing curfew hours, or adding airport infrastructure.

### SUMMARY OF THE INVENTION

It is a primary object of the present invention, therefore, to overcome the deficiencies of the prior art and to provide a method for creating and/or increasing the number of takeoff and landing slots available at an airport that does not rely on extending the airport hours of operation, reducing curfew hours, or adding airport infrastructure.

It is another object of the present invention to provide a method for creating early morning slots available at an airport.

It is an additional object of the present invention to provide a method for increasing the number of takeoff slots available at airports with curfews.

It is a further object of the present invention to provide a method for increasing the number of landing slots available at airports with curfews.

It is a further object of the present invention to provide a method for increasing the efficient use of early morning slots available at an airport whereby aircraft are on the runway ready for takeoff when an airport's morning curfew expires.

It is yet a further object of the present invention to provide a method for creating takeoff and landing slots at airports that are both slot-controlled and curfew-controlled.

It is yet an additional object of the present invention to provide a method for increasing airport facilities utilization and aircraft utilization without increasing costs incurred by an airport.

The aforementioned objects are achieved by providing a method for creating slots to increase the number of takeoff and landing slots at airports with curfew and slot controls, particularly at airports that are constrained from operation at specific times by curfews that limit the hours when aircraft can operate their engines. The present method is intended to be used in connection with aircraft equipped with onboard non-engine drive means controllable to power drive wheels to move the aircraft on the ground autonomously without complete reliance on the aircraft's engines. The present method is also intended to be used with aircraft that are moved on the ground by the range of available tugs or external tow vehicles and other aircraft-moving vehicles maintained at airports to move aircraft without operation of aircraft engines. These methods can move aircraft quietly and efficiently to a runway for takeoff and/or to a gate or other airport arrival location after landing, expanding the potential for creating additional slots at an airport.

Other objects and advantages will be apparent from the following description, drawings, and claims.

### BRIEF DESCRIPTION OF THE DRAWING

FIG. 1 is a schematic diagram of aircraft being moved on the ground without use of the aircrafts' engines and with the use of external aircraft-moving tugs or other tow vehicles in accordance with the method of creating slots of the present invention.

### DESCRIPTION OF THE INVENTION

To keep airline schedules operating on time and to reduce delays at airports that lack the capability for expanding their physical infrastructure and accommodating additional aircraft takeoffs and landings, airports have determined the number of flights an aircraft may handle in a defined period of time and allocated takeoff and landing slots corresponding to this number of flights to airlines. Certain takeoff and landing slots at certain airports and at certain times have become very desirable to airlines, and those takeoff and landing slots are, as a result, very valuable. Competition for such slots can be intense, especially at a busy airport like London's Heathrow, for example, where both takeoff and landing slots at the expiration of morning curfew are in great demand. As discussed above, adding new gates, terminal facilities, and runways to accommodate additional takeoff and landing slots to increase the total number of slots at an airport is difficult. The addition of slots is especially problematic at airports where hours of operation are restricted by curfew, and the likelihood of adding more gates or otherwise increasing infrastructure is, at best, a remote possibility or, more likely, nonexistent.

An airport with a night curfew is prohibited from allowing aircraft to land or take off early in the morning and late at night. A night curfew might extend, for example, from 11:00 PM to 6:00 AM. Local noise laws may prevent the operation of an aircraft's engines, whether on the ground or in the air during this time period. Consequently, airlines cannot schedule any flights that taxi, land or take off at an airport during the curfew period. Aircraft engines must be shut off during the curfew time period, which means that landing has to be completed, and the aircraft must be at a gate with its engines off by the start of curfew. Takeoff must also be completed before the start of curfew. Aircraft engines cannot be started before curfew is lifted and cannot, therefore, be used to move an aircraft to a runway for takeoff. In addition, aircraft landing cannot occur until after curfew has been lifted. The effect of these restrictions is to extend the curfew time period and reduce the available slots, as well as to limit the number of possible aircraft movements at an airport.

The method of the present invention overcomes these challenges and extends the time available for aircraft takeoff and landing, which effectively permits the creation of additional slots available before the curfew period begins as well as before it ends. Early morning takeoff slots and late night landing slots are especially attractive to many airlines and, consequently, are very valuable. The numbers of both early morning slots and late evening slots can be increased by the present method as described in the Example below. Once an airline obtains a takeoff or landing slot, that slot is an asset that the airline can trade, sell, or lease. These slots can be created for airlines with aircraft that can move or be moved on the ground without relying on thrust from operation of the main engines and will be able to be at the runway and ready for takeoff immediately when the curfew period has ended. As noted above, an airline may be able to acquire these slot assets in a variety of ways. The availability of aircraft that can land just before the curfew period begins and move or be moved to a gate or other parking location without the aircraft engines will also enable an airport to add late time slots just before the curfew period starts.

In accordance with the method of the present invention, an aircraft must be capable of being moved on the ground by a tow or taxi vehicle. An aircraft could also be equipped to be driven autonomously on the ground by at least one aircraft drive wheel that is powered by controllable non-engine drive means. Either method of maneuvering an aircraft on the ground without the operation of or reliance on the aircraft's main engines can be used to create additional slots in a curfew-controlled airport.

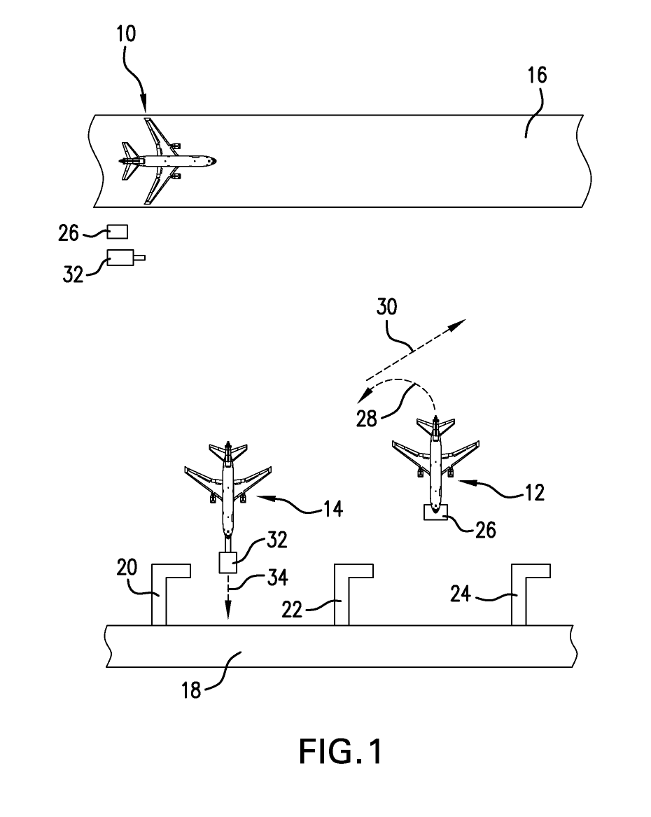

FIG. 1 illustrates, schematically, three aircraft 10, 12, and 14, a takeoff runway 16, and a terminal 18 with three attached passenger loading bridges 20, 22, and 24 providing a connection between the terminal and aircraft at gates associated with the passenger loading bridges. Aircraft 10 has been moved to a runway 16 landing as described herein and is ready to start its main engines just prior to takeoff as soon as the curfew period is over. Aircraft 12 is shown attached to a tow vehicle 26 being pushed back from the passenger loading bridge 22, initially to move in reverse along to a path represented by the arrow 28, and then towed in a forward direction, represented by the arrow 30, to runway 16 or to another runway for takeoff. Aircraft 14 is shown being towed by tow vehicle 32 into the terminal after landing on runway 16 in the direction indicated by arrow 34 to connect with the passenger loading bridge 20. Tow vehicles 26 and 32 are shown near the runway 16, waiting to be connected to aircraft (not shown) that have landed to move them to a passenger loading bridge and gate at the terminal 18. One or more onboard non-engine drive means (not shown) may also be provided to power and drive one or more of an aircraft's nose or main wheels to move the aircraft on the ground without relying on thrust from the aircraft's engines.

In accordance with the present method for creating airport slots, the aircraft's engines can be turned off very shortly after landing and can remain off until very shortly before takeoff, which significantly reduces noise and engine emissions. Substantially eliminating reliance on the use of the aircraft engines during taxi also reduces aircraft fuel consumption and eliminates the jet blast, engine ingestion, noise, and air pollution associated with operation of an aircraft's engines on the ground. Consequently, not only is a safer, quieter, and less congested runway and ramp environment possible, but an aircraft can proceed relatively quietly to a runway for takeoff and be ready for immediate takeoff when the curfew period is over in the early morning. An aircraft can also land at night and travel to a gate without significant noise or engine emissions.

Ground movement of an aircraft without operation of its engines can be produced by different methods, as noted above. The use of tugs and tow vehicles can be used to move aircraft and is currently used primarily to push aircraft in reverse from a gate or parking location to a point where the aircraft can start its engines and move in a forward direction to a takeoff runway. In accordance with the present method for creating slots, a tug, tow vehicle, or other aircraft-moving vehicle could be used to move an aircraft during all ground movement, upon landing and prior to takeoff, so that operation of the aircraft's engines is not required. An aircraft could also be moved autonomously by controlling the operation of non-engine onboard drive means mounted to drive one or more of the aircraft's wheels without requiring a tow vehicle.

Any of the variety of aircraft-moving vehicles available for attachment to aircraft to move them on the ground without engines is contemplated for use with the present method of creating slots at an airport. Most tow vehicles or tugs presently in use are operator-driven vehicles that may be attached to an aircraft's nose landing gear with a tow bar or are vehicles that do not use a tow bar, but, instead, lift the aircraft's nose landing gear and support it above the ground surface to enable the tug to move the aircraft. Tow vehicles of either of these types will require ground personnel to connect and disconnect them to an aircraft and then operate them to move the aircraft. Since such tow vehicles are already widely used at most airports, modifying their use to move aircraft longer distances to takeoff locations and from landing locations to gates, thereby creating additional slots as described herein, should not be difficult.

Tow vehicles capable of moving aircraft on the ground with minimal assistance and involvement from ground personnel are also available. The automated aircraft towing vehicle system described in U.S. Pat. No. 6,305,484 by LeBlanc, the disclosure of which is incorporated herein by reference, for example, has a towing tractor that is adapted for remote steering, acceleration, and braking control to move an aircraft on the ground to a desired location. Once the aircraft has reached the desired location, the tow vehicle is detached from the aircraft, which could be accomplished remotely, so that the aircraft can take off. An unmanned aircraft transfer system described in U.S. Pat. No. 7,975,959 by Perry et al, the disclosure of which is incorporated herein by reference, is controllable to move an aircraft on the ground. A transfer module moves the aircraft by skid steering, and control of this function is provided by one or more aircraft components. The transfer module, generally controlled remotely, is attached to the aircraft and then detached from the aircraft when it has reached a designated location. As with the use of a towing tractor, the aircraft's engines are not needed to move the aircraft with the aforementioned transfer module. Consequently, these and other available aircraft towing and/or aircraft moving systems can be used to create additional slots at curfew-controlled airports.

Although tow vehicles, including the variations described above, can effectively move aircraft on the ground without using the aircraft engines, using a non-engine onboard drive means to move aircraft to and from runways near curfew time presents the additional benefit of not having to retrieve and find space for tow vehicles, transfer modules, and other similar apparatus that must be attached to and detached from aircraft to move them.

An aircraft moved by a tow vehicle or equipped with one or more onboard non-engine drive means as described above can effectively generate additional slots by allowing earlier actual takeoffs and landings. The Example below demonstrates this.

### EXAMPLE

### Airport With Curfew that Expires at 6:00 AM

### Current Practice

All aircraft required to be at gates until 6:00 AM. At 6:00 AM, aircraft can be pushed back and leave gates, and engines can be turned on. Aircraft line up on runway for takeoff. The earliest flight cannot be scheduled to depart until 6:15 AM or later. The earliest landing times available when curfew expires are among the most desirable, particularly at international airports, and aircraft landing at that time may have a long wait for gates, which are filled with aircraft waiting to be pushed back, turn on their engines and depart. Arriving aircraft may be stacked in the air waiting for landing approval and on the ground waiting for gates, while departing aircraft are waiting to be moved to where they can start their engines and dash for the runways and takeoff.

### With the Method of the Present Invention

Aircraft attached to tugs, tow vehicles, or transfer apparatus, or are equipped with onboard non-engine drive means, as described above, can be moved quietly without operation of the aircrafts' engines to a takeoff runway prior to the expiration of 6:00 AM curfew, line up in position for takeoff, and be ready to start main engines at 6:00 AM for a 6:05 AM departure. Depending on the type of tug, tow vehicle, or transfer apparatus, an aircraft may have to wait at the edge of a takeoff runway while the tug or other vehicle or apparatus is detached and the aircraft's engines can be started to move the aircraft onto the runway into the queue for takeoff.

Assuming 2 minutes per takeoff, 5 more aircraft can be lined up ready to take off before the 6:15 AM earliest departure now possible, creating 5 additional slots per runway. Two runways used in this manner would produce 10 additional slots. At a busy airport like Heathrow where early morning takeoff slots sell for £2 million to £3 million, the value of the first ten aircraft moved to a takeoff runway as described herein and ready to fly out of Heathrow would have a value in the range of about £2 million to £3 million (US $3 million to US $5 million)and possibly more.

At an airport with a 30 minute taxi time from a gate to a runway takeoff location, an aircraft can be attached to a tow vehicle or transfer apparatus and moved from the gate quietly at 5:30 AM and be ready on or near the runway to start engines at 6:00 AM for a 6:05 AM takeoff. This frees gate space to load the next departing flight while the aircraft with the 6:05 AM slot is on the runway. Assuming 2 minutes per takeoff and 3 runways, 30 additional takeoff events are created without adding more gates. The addition of these 30 slots effectively adds 3 to 5 more gates to the airport. At Heathrow, for example, each gate may have a worth that approaches about £3 million per year. This value may be significantly increased for landing aircraft.

Aircraft arriving as the curfew is lifted, whether towed or equipped with an onboard non-engine drive means, will be able to proceed directly to assigned gates upon landing since these gates have been vacated by the earlier departing aircraft, as described above, and are available for the arriving aircraft. Significant time and expense savings should result from this efficient movement of aircraft.

The method of the present invention permits the evening curfew starting time to be set to later than at present, once airports realize that aircraft engine noise between landing and the gate will be, at most, minimal as aircraft are moved without operating engines. The substantial elimination of noise pollution achieved by the present method makes it possible to extend the commencement of the evening curfew, giving airports an estimated 30 minutes additional use of its facilities at the end of the day without any expansion of the airport's infrastructure. A later curfew creates increased evening landing slots and increases gate capacity. Gate throughput is also increased, which decreases operating costs for airports and airlines.

Aircraft moved without operation of their engines in accordance with the present invention, therefore, can enable airlines to schedule earlier and later arrival and departure flight times than is currently possible. This allows an airport to expand the number of possible takeoffs and landings in a set time period, effectively creating slots and expanding an airport's available capacity without requiring expansion of the airport's actual infrastructure.

While the present invention has been described with respect to preferred embodiments, this is not intended to be limiting, and other arrangements and structures that perform the required functions are contemplated to be within the scope of the present invention.

### INDUSTRIAL APPLICABILITY

The method of creating airport slots of the present invention will find its primary applicability in adding additional takeoff and landing slots to curfew-controlled airports and expanding the opportunities for airlines and airports to increase gate utilization and, therefore, scheduling capacity without adding airport infrastructure.

1. A method for increasing airport capacity comprising creating slots at a curfew-controlled airport, wherein aircraft are moved on the ground at said airport during a time before or after a curfew period expires or starts without operation of the aircraft engines by a method of moving aircraft comprising towing an aircraft with a tow vehicle, moving an aircraft with an aircraft-moving transfer module, or driving an aircraft with a non-engine drive means so that a departing aircraft is at a takeoff location ready for takeoff when said curfew period expires and an arriving aircraft landing just before said curfew period starts is moved to a parking location after said curfew period starts.

2. The method of claim 1, wherein an aircraft is moved on the ground by towing with a tow vehicle attached to said aircraft.

3. The method of claim 2, further comprising towing said departing aircraft by said tow vehicle from an airport parking location to an airport runway takeoff location prior to a takeoff curfew time, detaching said tow vehicle from said aircraft at the takeoff location, and starting said aircraft engines at the time said curfew period expires.

4. The method of claim 2, further comprising towing said arriving aircraft by said tow vehicle from a runway landing location to an airport parking location after said arriving aircraft has shut down its engines at said curfew period start time.

5. The method of claim 1, further comprising moving said arriving aircraft from a landing location to an airport parking location after start of said curfew period and moving said departing aircraft from an airport parking location to a runway takeoff location prior to start of said curfew period by an aircraft-moving transfer module.

6. The method of claim 1, further comprising moving said arriving aircraft from a landing location to an airport parking location after start of said curfew period and moving said departing aircraft from an airport parking location to a runway takeoff location prior to start of said curfew period by a non-engine drive means.

7. The method of claim 1, further comprising controlling said tow vehicle and said aircraft transfer module to move said departing and arriving aircraft manually or automatically from locations near or remote from said aircraft.

8. The method of claim 1, wherein said curfew time period comprises a period of time extending from a time after which aircraft are prohibited from landing or taking off at said airport to a time before which aircraft are prohibited from taking off or landing at said airport.

9. A method comprising increasing takeoff and landing slots at an airport where landings and takeoffs are restricted during a curfew period when aircraft engines are prohibited from operation, wherein aircraft are moved by tow vehicles or aircraft-moving transfer modules quietly on the ground without operation of said aircraft's main engines during said curfew period, and said aircraft are enabled to take off substantially immediately at an expiration of a curfew period or to land substantially immediately prior to a start of a curfew period.

10. The method of claim 9, further comprising moving said aircraft on the ground from a parking location to a takeoff runway prior to expiration of the curfew period, detaching said tow vehicle or aircraft-moving transfer module, activating said aircraft's main engines, and causing the aircraft to take off substantially immediately at the expiration of said curfew period.

11. The method of claim 9, further comprising, upon landing of said aircraft substantially immediately prior to start of the curfew period, deactivating said aircraft's engines, attaching a tow vehicle or aircraft-moving transfer module to said aircraft, and moving said aircraft from a location where said engines were deactivated to an arrival location.

12. The method of claim 9, further comprising moving a plurality of aircraft taking off and landing at an airport by tow vehicles or aircraft-moving transfer modules quietly on the ground without operation of said aircraft's main engines during said curfew period, enabling said plurality of aircraft to take off substantially immediately at an expiration of a curfew period or to land substantially immediately prior to a start of a curfew period and increasing takeoff and landing slots available at said airport above a number of said slots available when said plurality of aircraft are not moved by tow vehicles or aircraft-moving transfer modules during said curfew period.
